(19) United States
(12) Patent Application Publication
(10) Pub. No.: US 2026/0278934 A1
(43) Pub. Date: Sep. 17, 2026

(54) METHOD, APPARATUS, DEVICE AND MEDIUM FOR OBJECT RECONSTRUCTION

(71) Applicant: Beijing Zitiao Network Technology Co., Ltd., Haidian District, Beijing (CN)

(72) Inventors: Feida Zhu, Beijing (CN); Congyi Wang, Beijing (CN); Shilei Wen, Beijing (CN)

(21) Appl. No.: 19/168,666

(22) PCT Filed: Mar. 13, 2024
(86) PCT No.: PCT/CN2024/081486

§ 371 Date: Sep. 24, 2025

(30) Foreign Application Priority Data
Mar. 31, 2023 (CN) 202310342539.4

(51) Int. Cl. G06T 17/20; G06V 10/77; G06V 10/774

(52) U.S. Cl. CPC G06T 17/20; G06V 10/7715; G06V 10/774

(57) ABSTRACT

Embodiments of this disclosure relate to a method, apparatus, device and medium for object reconstruction, and the method includes: obtaining a to-be-processed image, wherein the to-be-processed image includes a to-be-reconstructed target object; obtaining three-dimensional reconstruction mesh information of a target object corresponding to the to-be-processed image through a pre-trained information prediction model, wherein the three-dimensional reconstruction mesh information includes vertex information of a three-dimensional reconstruction mesh and a specified parameter for constructing the three-dimensional reconstruction mesh, the specified parameter is configured to constrain the vertex information; and constructing, based on the vertex information of the three-dimensional reconstruction mesh, a three-dimensional reconstruction mesh of the target object. According to the embodiments of this disclosure, the object reconstruction effect can be effectively improved.

This application claims priority to Chinese Patent Application No. 2023103425394, filed on Mar. 31, 2023, entitled “METHOD, APPARATUS, DEVICE AND MEDIUM FOR OBJECT RECONSTRUCTION”, the entirety of which is incorporated herein by reference.

### FIELD

The present disclosure relates to the field of computer technologies, and in particular, to a method, apparatus, device, and medium for object reconstruction.

### BACKGROUND

In various fields such as MR field and VR field, object reconstruction techniques may be involved, such as hand reconstruction by a pre-trained model, generate a three-dimensional reconstruction mesh corresponding to a hand, and present the three-dimensional reconstruction mesh to a user. However, the object reconstruction techniques used in the related art may achieve a poor effect, such as poor mesh precision or poor reconstruction stability.

### SUMMARY

In order to solve the above technical problems or at least partially solve the above technical problems, the present disclosure provides a method, apparatus, device, and medium for object reconstruction.

According to a first aspect, a method for object reconstruction is provided in an embodiment of the present disclosure, and the method includes: obtaining a to-be-processed image; wherein the to-be-processed image comprises a to-be-reconstructed target object; obtaining three-dimensional reconstruction mesh information of a target object corresponding to the to-be-processed image through a pre-trained information prediction model; wherein the three-dimensional reconstruction mesh information comprises vertex information of a three-dimensional reconstruction mesh and a specified parameter for constructing the three-dimensional reconstruction mesh, the specified parameter is configured to constrain the vertex information; and constructing, based on the vertex information of the three-dimensional reconstruction mesh, a three-dimensional reconstruction mesh of the target object.

According to a second aspect, an apparatus for object reconstruction is further provided in an embodiment of the present disclosure, including: an image obtaining module configured to obtain a to-be-processed image; wherein the to-be-processed image comprises a to-be-reconstructed target object; an information obtaining module configured to obtain three-dimensional reconstruction mesh information of a target object corresponding to the to-be-processed image through a pre-trained information prediction model; wherein the three-dimensional reconstruction mesh information comprises vertex information of a three-dimensional reconstruction mesh and a specified parameter for constructing the three-dimensional reconstruction mesh, the specified parameter is configured to constrain the vertex information; and a mesh construction module configured to construct, based on the vertex information of the three-dimensional reconstruction mesh, a three-dimensional reconstruction mesh of the target object.

According to a third aspect, an electronic device is further provided in an embodiment of the present disclosure, including: a processor; a memory for storing executable instructions for the processor; and the processor being configured to read the executable instructions from the memory and execute the instructions to implement the method for object reconstruction provided in the embodiments of the present disclosure.

According to a fourth aspect, a computer-readable storage medium is further provided in an embodiment of the present disclosure. The storage medium stores a computer program, and the computer program is configured to implement the method for object reconstruction provided in the embodiments of the present disclosure.

It should be understood that the content described in this section is not intended to identify key or important features of the embodiments of the present disclosure, nor is it intended to limit the scope of the present disclosure. Other features of the present disclosure will become readily understood from the following description.

### BRIEF DESCRIPTION OF DRAWINGS

The drawings herein are incorporated in and constitute a part of this specification, illustrating embodiments consistent with the present disclosure and, together with the description, explain the principles of the present disclosure.

In order to more clearly illustrate the technical solutions in the embodiments of the present disclosure or in the prior art, the accompanying drawings used in the description of the embodiments or the prior art will be briefly introduced below. It is obvious to those skilled in the art that other drawings may be obtained according to these drawings without creative labor.

FIG. 1 is a schematic flowchart of a method for object reconstruction according to an embodiment of the present disclosure;

FIG. 2 is a schematic structural diagram of an information prediction model according to an embodiment of the present disclosure;

FIG. 3 is a schematic structural diagram of an information prediction model according to an embodiment of the present disclosure;

FIG. 4 is a schematic structural diagram of a first information interaction unit according to an embodiment of the present disclosure;

FIG. 5 is a schematic structural diagram of an information prediction model according to an embodiment of the present disclosure;

FIG. 6 is a schematic structural diagram of an information prediction model according to an embodiment of the present disclosure;

FIG. 7 is a schematic structural diagram of an apparatus for object reconstruction according to an embodiment of the present disclosure;

FIG. 8 is a schematic structural diagram of an electronic device according to an embodiment of the present disclosure.

### DETAILED DESCRIPTION

In order to be able to more clearly understand the above purposes, features and advantages of the present disclosure, the solutions of the present disclosure will be further described below. It should be noted that, without confliction, embodiments of the present disclosure and features in the embodiments may be combined with each other.

Many specific details are set forth in the following description to facilitate a thorough understanding of the present disclosure, but the present disclosure may also be implemented in other ways other than those described herein; it is apparent that the embodiments in the specification are only part of the embodiments of the present disclosure, not all embodiments.

The inventor through research found that there are mainly two existing object reconstruction technologies. One technology employs a parameterized model to perform object reconstruction, the parameterized model is, for example, a MANO model. Taking a hand as an object as an example, a posture parameter (which may also be referred to as a posture coefficient) and a shape parameter (which may also be referred to as a shape coefficient) of a hand in a hand image may be obtained through a pre-trained MANO model. For example, a three-dimensional mesh of the hand may be reconstructed by using a 48-dimensional posture parameter and a 10-dimensional shape parameter, and totally includes 778 vertices and 1536 faces. Another technique employs a deep model for object reconstruction, directly predicting all vertex positions of the hand mesh, such as predicting positions of 778 vertices directly, thereby reconstructing a three-dimensional mesh of the hand based on the vertex positions. However, although the reconstruction stability is relatively good in the manner of performing object reconstruction by using the parameterized model, the accuracy of the obtained three-dimensional reconstruction mesh is generally not high. Although mesh reconstruction precision may be higher in the manner of performing object reconstruction by using the non-parameterized model, the reconstruction stability is poor. For example, a three-dimensional reconstruction mesh with a larger shape and/or posture deviation from the actual hand may be finally obtained, and a bad case is generated. In order to solve the above problems, embodiments of the present disclosure provide a method, apparatus, device, and medium for object reconstruction, which are described in detail below.

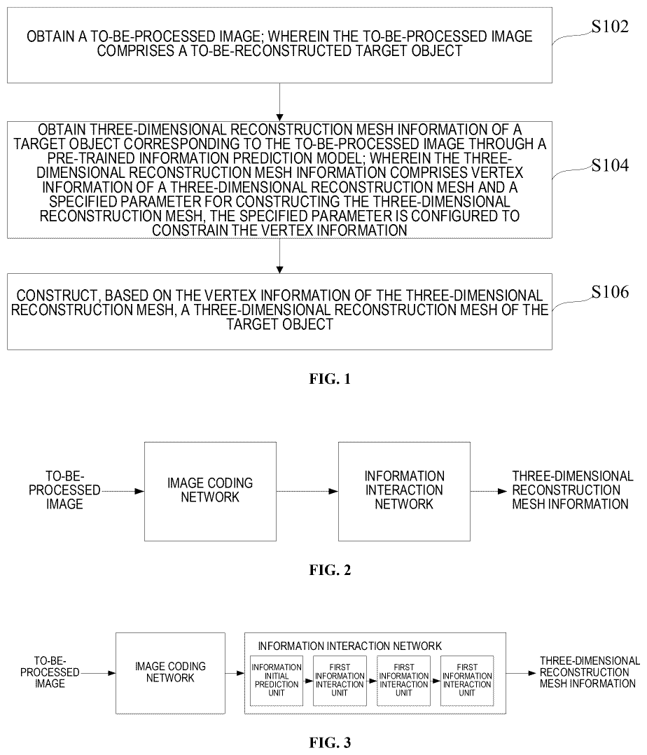

FIG. 1 is a schematic flowchart of a method for object reconstruction according to an embodiment of the present disclosure, the method may be implemented by an apparatus for object reconstruction. The apparatus may be implemented by software and/or hardware, and may generally be integrated in electronic devices. As shown in FIG. 1, the method mainly includes the following steps S102 to S106.

Step S102: obtain a to-be-processed image; wherein the to-be-processed image comprises a to-be-reconstructed target object.

The type of the target object is not limited in the embodiments of the present disclosure, and for example, the target object may be a hand or other designated parts in a human body, and the target object may also be the whole human body; or the target object may also be an animal (such as a cat, a dog and etc.) or a robot, which is not limited herein. In addition, the number of the target objects is not limited in the embodiments of the present disclosure, for example, there may be a plurality of target objects, there may also be some association between the plurality of target objects, for example, the target object includes two hands.

Step S104: obtain three-dimensional reconstruction mesh information of a target object corresponding to the to-be-processed image through a pre-trained information prediction model; wherein the three-dimensional reconstruction mesh information comprises vertex information of a three-dimensional reconstruction mesh and a specified parameter for constructing the three-dimensional reconstruction mesh, the specified parameter is configured to constrain the vertex information.

The information prediction model may be a neural network model, that may analyze the to-be-processed image and output vertex information of the three-dimensional reconstruction mesh of the target object. At the same time, the neural network model may output a specified parameter for constructing the three-dimensional reconstruction mesh, and the specified parameter includes, but is not limited to, a shape parameter and/or a posture parameter. It may be understood that the model used in the related art is mainly used for single prediction of mesh vertex information, and the three-dimensional reconstruction mesh may be constructed directly with the vertex information; or the single prediction is used for constructing the specified parameter of the mesh, and the three-dimensional reconstruction mesh may also be constructed directly with the specified parameter, so that the vertex information and the specified parameter will not be predicted at the same time. In the embodiment of the present disclosure, the information prediction model simultaneously determines a prediction of the vertex information and the specified parameter, and the specified parameter constrains the vertex information, that is, the vertex information is affected by the specified parameter. In other words, the information prediction model in the embodiments of the present disclosure considers the influence of factors of the specified parameters in the process of determining a prediction of the vertex information, thereby ensuring the stability of the vertex information. In addition, the manner in which the vertex information is affected by the specified parameter is not limited in the embodiments of the present disclosure, for example, the specified parameter may directly affect the vertex information, the specified parameter may also potentially or indirectly affect the vertex information. Meanwhile, the vertex information may also affect the specified parameter. For example, considering that the precision of the vertex information is relatively higher, and the stability of the specified parameter is relatively higher, the vertex information may first be made to affect the specified parameter, thereby improving the precision of the specified parameter, and then implicitly affect the vertex information by using the specified parameter with improved precision, thereby further improving the stability of the vertex information.

Step S106, construct, based on the vertex information of the three-dimensional reconstruction mesh, a three-dimensional reconstruction mesh of the target object.

Because the precision of constructing the mesh through the vertex information is higher, the three-dimensional reconstruction mesh of the target object may be directly constructed by adopting the vertex information in the embodiment of the present disclosure, and moreover, the vertex information is constrained by the specified parameters, so that the stability is higher, and the situation of a bad case can be effectively avoided.

In conclusion, the information prediction model adopted in the foregoing technical solutions provided in the embodiments of the present disclosure not only determines a prediction of the vertex information of the three-dimensional reconstruction mesh of the target object in the to-be-processed image, but also determines a prediction of the specified parameter used to construct the three-dimensional reconstruction mesh. The specified parameter is used to constrain the vertex information. The information prediction model ensures the mesh precision by predicting the vertex information, and ensure the reconstruction stability by constraining the vertex information by using the specified parameter, thereby effectively improving the object reconstruction effect.

Further, an embodiment of the present disclosure provides some specific implementation examples of constraining vertex information by using specified parameters, and specifically, obtaining the three-dimensional reconstruction mesh information of the target object corresponding to the to-be-processed image through the pre-trained information prediction model includes: obtaining, based on an attention mechanism, the three-dimensional reconstruction mesh information of the target object corresponding to the to-be-processed image through the pre-trained information prediction model. It may be understood that the attention mechanism may establish an association between a plurality of features extracted from the to-be-processed image, and learn a dependency relationship between the plurality of features. By analyzing and processing the to-be-processed image through the attention mechanism, it is helpful to more accurately determines a prediction of the three-dimensional reconstruction mesh information of the target object in the to-be-processed image.

In order to further ensure accuracy and reliability of the prediction result, embodiments of the present disclosure provide two manners (Manner 1 and Manner 2) of obtaining three-dimensional reconstruction mesh information of a target object corresponding to a to-be-processed image through a pre-trained information prediction model based on an attention mechanism, the two manners both are used to improve the attention mechanism. And an attention matrix (also referred to as an influence matrix) is additionally introduced, so that the information prediction model performs information prediction by using the attention matrix. The two manners may be implemented separately, or may be implemented in combination, and may be flexibly selected based on requirements, and the following separately describes the Manner 1 and the Manner 2.

Manner 1: Obtain three-dimensional reconstruction mesh information of a target object corresponding to a to-be-processed image through using a pre-trained information prediction model based on a first attention matrix, wherein the first attention matrix is configured to at least retain unidirectional influence of vertex information on a specified parameter, so that the influenced specified parameter reversely constrains the vertex information, thereby improving stability of the vertex information.

Specifically, embodiments of the present disclosure introduce a first attention matrix for the attention mechanism, and is configured to retain unidirectional influence of the specified parameter on the vertex information when an attention operation is performed on the to-be-processed image. That is, the information prediction model performs information prediction based on the attention mechanism, and more focuses on the unidirectional influence of the vertex information on the specified parameters (posture, shape parameters, etc.). During specific implementation, the first attention matrix may mask direct influence of the specified parameters on the vertex information through a mask mode, and retain the unidirectional influence of the vertex information on the specified parameters, thereby improving the precision of the specified parameters by the vertex information with relatively high precision. So that the vertex information is implicitly influenced by the specified parameters with higher stability and improved precision, and the stability of the vertex information is further improved while the vertex information precision is guaranteed. In summary, in this way, the vertex information may be implicitly constrained with a specified parameter with strong stability, thereby ensuring mesh precision and reconstruction stability at the same time. Based on the foregoing, if the target object includes a first object and a second object associated with each other, the first attention matrix may further be configured to retain unidirectional influence of vertex information of the first object on a specified parameter of the first object, and retain unidirectional influence of vertex information of the second object on a specified parameter of the second object. That is, the first attention matrix focuses more on influence of the vertex information of each object themselves on the specified parameter, and excludes direct influence of the objects with each other, thereby ensuring the prediction accuracy and reliability of the three-dimensional reconstruction mesh information of each object on the level of the object itself.

Manner 2: The target object includes a first object and a second object associated with each other; based on a second attention matrix, obtain the three-dimensional reconstruction mesh information of the target object corresponding to the to-be-processed image through a pre-trained information prediction model, wherein the second attention matrix is configured to at least retain mutual influence between vertex information of the first object and vertex information of the second object, and is configured to retain mutual influence between a specified parameter of the first object and a specified parameter of the second object. Further, the second attention matrix is further configured to retain unidirectional influence of the vertex information of the first object on the specified parameter of the second object, and is configured to retain unidirectional influence of the vertex information of the second object on the specified parameter of the first object. Similarly, the second attention matrix may mask the influence between the specified parameter of the first object and the vertex information of the first object, the influence between the specified parameter of the second object and the vertex information of the second object through a mask mode, but focuses on the influence between the first object and the second object, thereby ensuring the prediction accuracy and reliability of the three-dimensional reconstruction mesh information of each object on the object interaction level. Through the foregoing manners, information prediction may be performed based on mutual influence between two objects. For example, taking the first object and the second object as a left hand and a right hand, respectively, the foregoing manners may retain mutual influence between vertex information of the left hand and vertex information of the right hand, and mutual influence between specified parameters of the left and right hands, influence of left hand vertex information on the right hand specified parameter, and influence of the right hand vertex information on the left hand specified parameter. The foregoing manners fully takes into account that there may be occlusion or interaction between the left and right hand. By considering the interaction between the left and right hand during information prediction, it helps to determine a prediction of the three-dimensional reconstructed grid information of the left and right hand more accurately. In addition, in practical, the above influence may be represented by the weight coefficients of the correlation between the left and right hand in the attention mechanism, moreover, or may be implemented in other manners, which is not limited herein.

In practical, the Manner 1 and/or the Manner 2 described above may be flexibly selected for information prediction based on the number or type of the target objects. In some implementations, information prediction may be first performed in Manner 1, and then the three-dimensional reconstruction mesh information of the target object corresponding to the to-be-processed image is further determined based on the prediction result of Manner 1. Specifically, the Manner 1 focuses more on the feature of the object, and can perform information prediction on the level of the object itself, so as to obtain prediction information with a certain accuracy. Manner 2 focuses more on the feature between the two objects, and Manner 2 can obtain association feature between the two objects based on the prediction information obtained in Manner 1, for example, the information prediction model may learn an intrinsic constraint relationship existing between the two objects, thereby further improving the prediction precision of each target object.

In addition, when the three-dimensional reconstruction mesh information of the target object corresponding to the to-be-processed image is predicted based on the target attention matrix (the first attention matrix and/or the second attention matrix), attention parameters corresponding to the target attention matrix and the information prediction model may be combined to determine a prediction of the three-dimensional reconstruction mesh information of the target object corresponding to the to-be-processed image. For example, the attention parameters may include Q (query, query parameter), K (key, index parameter), and V (value, value parameter). The target attention matrix may be a multi-dimensional matrix formed by 0 and 1, the multi-dimensional matrix includes a plurality of elements, and the plurality of elements are configured to represent a direct influence between the specified parameter and the vertex information, for example, if the target object includes a first object and a second object, the plurality of elements are configured to represent the direct influence between a specified parameter of the first object, vertex information of the first object, a specified parameter of the second object and vertex information of the second object. The element may be represented by 0 or 1, for example, the influence may be retained by setting 1, and the influence may be masked by setting 0. It should be noted that the above is merely an example implementation of an attention matrix, and the embodiments of the present disclosure do not limit the specific implementation of the attention matrix.

For ease of understanding, embodiments of the present disclosure provide an example of an information prediction model. In some implementations, referring to a schematic structural diagram of an information prediction model shown in FIG. 2, the information prediction model includes an image coding network and an information interaction network.

The image coding network is configured to perform feature extraction processing on the to-be-processed image to obtain a feature vector and a feature map(s) corresponding to the to-be-processed image. The number of the feature map(s) may be one or more, and scales of a plurality of feature maps may be different. The structure of the image coding network is not limited in the embodiments of the present disclosure, for example, the image coding network may adopt a ResNet50 network or the like as a backbone network. And the coding network may be pre-trained to realize auxiliary vision tasks such as target object segmentation and key point prediction. For example, the image coding network may include an encoding unit and a decoding unit, the encoding unit may perform multi-level feature extraction on the to-be-processed image to obtain a required feature vector, and the feature vector may be, for example, a GAP (Global Average Pooling) feature vector. Specifically, the encoding unit may obtain a multi-scale downsampling result by performing multi-level downsampling on the to-be-processed image, and generate the feature vector based on a downsampling result. Further, multi-level upsampling may be further performed based on the feature vector to obtain a multi-scale upsampling result; based on a scale size, the multi-scale upsampling result and the multi-scale downsampling result are respectively subjected to corresponding convolution processing, to obtain a multi-scale feature map(s).

The information interaction network is configured to obtain three-dimensional reconstruction mesh information of the target object through an attention mechanism based on the feature vector and the feature map(s). In some specific implementations, the information interaction network includes an information initial prediction unit and a first information interaction unit(s).

For example, the information initial prediction unit is configured to generate initial information of the three-dimensional reconstruction mesh of the target object based on the feature vector. The information initial prediction unit may, for example, include an MLP (Multi-Layer Perceptron) neural network, the information initial prediction unit generates initial information of the three-dimensional reconstruction mesh of the target object based on the feature vector through the MLP neural network, and initial information of the three-dimensional reconstruction mesh includes initial vertex information and an initial specified parameter.

The first information interaction unit(s) is configured to determine a prediction of the three-dimensional reconstruction mesh information of the target object through the attention mechanism based on the initial information and the feature map(s). In practical, the number of the first information interaction units may be one, to ensure accuracy and stability of information prediction, the number of the first information interaction units may also be a plurality, and the plurality of first information interaction units are connected in series. Specifically, the plurality of first information interaction units may be directly connected in series, or may be indirectly connected in series, for example, two adjacent first information interaction units may also be indirectly connected across another network layer, such as a sampling layer. The structures of the plurality of first information interaction units may be the same, and the operation principles may also be the same, both of which are to determine a prediction of the three-dimensional reconstruction mesh information of the target object through the attention mechanism based on the input information. Specifically, an initial first information interaction unit is configured to determine a prediction of the three-dimensional reconstruction mesh information of the target object through the attention mechanism based on the initial information and the feature map(s). A non-initial first information interaction unit is configured to redetermine a prediction of the three-dimensional reconstruction mesh information of the target object through the attention mechanism based on the feature map(s) and three-dimensional reconstruction mesh information output by a preceding first information interaction unit, and the number of vertices included in vertex information output by the non-initial first information interaction unit is greater than the number of vertices included in vertex information determined by the preceding first information interaction unit. In practical, when the feature map(s) comprises a plurality of feature maps, and different feature maps have different sizes, feature maps adopted by different first information interaction units are different. Specifically, the plurality of feature maps correspond to a plurality of target maps, the target map is obtained by sampling the feature map with a predetermined multiple, and for example, the plurality of feature maps may be respectively sampled based on one or more predetermined multiples, to obtain a target map (that is, a feature map sampled by a predetermined multiple) corresponding to each feature map, and each feature map corresponds to at least one target map. Because the scales of different feature maps are different, the scales of the target maps corresponding to different feature maps are different. The target map is configured to be inputted to the first information interaction unit, and the target maps inputted to different first information interaction units may be different. In some specific implementation examples, the feature map is in a one-to-one correspondence with the target map, the number of feature maps is equal to the number of target maps, and is also equal to the number of the first information interaction units. The first information interaction unit is in a one-to-one correspondence with the target map, so that the first information interaction unit can further perform fine prediction based on the vertex information and the specified parameter and the target graph inputted to the first information interaction unit, and gradually improve the accuracy of the vertex information and the specified parameter through a plurality of serial first information interaction units. Through the above method, more accurate and comprehensive three-dimensional reconstruction mesh information can be predicted layer by layer.

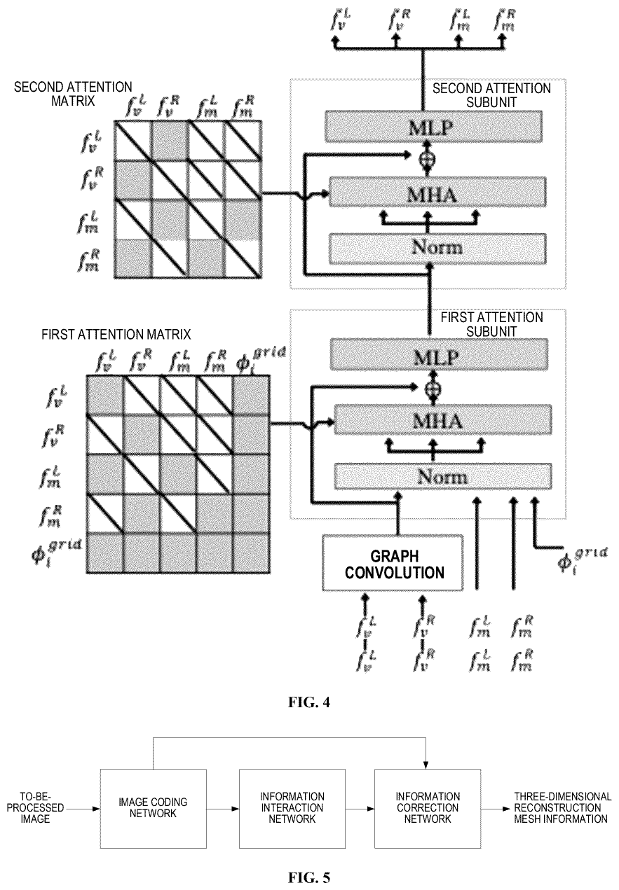

For example, based on FIG. 2, an embodiment of the present disclosure further illustrates in FIG. 3 that the information interaction network includes an information initial prediction unit and three first information interaction units, and the three first information interaction units are connected in series. The number of mesh vertices predicted by an initial first information interaction unit is 63, the number of mesh vertices predicted by a second first information interaction unit is 126, the number of mesh vertices predicted by a third first information interaction unit is 252, and finally the number of vertices is increased to 778 through a manner such as 1*1 convolution layer based on the information of the 252 vertices. At the same time, the three first information interaction units also determine a specified parameter, which will not be repeated here. FIG. 3 is merely an example, and in practical, the number of the first information interaction units may also be more or less, which is not limited herein.

Further, when the target object includes a first object and a second object associated with each other, a schematic structural diagram of a first information interaction unit as shown in FIG. 4, the first information interaction unit includes a graph convolution subunit and two attention subunits connected in series.

The graph convolution subunit is configured to generate a vertex association feature based on vertex information of a first object and vertex information of a second object that are inputted to the information interaction unit, the vertex association feature is configured to be inputted to an initial attention subunit. The initial attention subunit (such as the first attention subunit in FIG. 4) retains unidirectional influence of the vertex information of the first object on a specified parameter of the first object based on a first attention matrix, and retains unidirectional influence of the vertex information of the second object on a specified parameter of the second object; an end attention subunit (such as the second attention subunit in FIG. 4), based on the second attention matrix, retains mutual influence between the vertex information of the first object and the vertex information of the second object, and retains mutual influence between the specified parameter of the first object and the specified parameter of the second object, and retains unidirectional influence of the vertex information of the first object on the specified parameter of the second object, and retains unidirectional influence of the vertex information of the second object on the specified parameter of the first object. FIG. 4 illustrates a first attention matrix corresponding to a first attention subunit and a second attention matrix corresponding to a second attention subunit. For ease of understanding, the following explains:

The first attention matrix is configured to represent the first attention subunit retaining unidirectional influence of the vertex information of an independent object on the specified parameter of the independent object, where the first object and the second object are left and right hands as an example,

$${f}_{v}^{L}$$

represents left hand vertex information,

$${f}_{v}^{R}$$

represents right hand vertex information,

$${f}_{m}^{L}$$

represents a left hand specified parameter, and

$${f}_{m}^{R}$$

represents a right hand specified parameter. A white square in the first attention matrix represents a mask for masking influence, and a value of a corresponding element in the matrix may be represented by 0. The gray square represents retaining influence of information displayed horizontally on the upper side of the first attention matrix on information displayed vertically on the left side of the first attention matrix, a value of a corresponding element in the matrix may be represented by 1, and the square with a diagonal bar represents masking the influence of the information displayed horizontally on the upper side of the first attention matrix on the information displayed vertically on the left side of the first attention matrix. For example, by setting 1, influence of

$${f}_{v}^{L} on {f}_{m}^{L}$$

and influence of

$${f}_{v}^{R} on {f}_{m}^{R}$$

are retained; by setting 0, influence of

$${f}_{m}^{L} on {f}_{v}^{L} ,$$

influence of

$${f}_{m}^{R} on {f}_{v}^{R} ,$$

influence of

$${f}_{v}^{R} on {f}_{m}^{L}$$

and the influence of

$${f}_{v}^{L} on {f}_{m}^{R}$$

are masked, so that the first attention subunit is more focused about the influence of the vertex information of each object itself on the specified parameters. It should be noted that the above influences all represent the direct impact of participating in the operation of the attention subunit. That is, unidirectional direct influence of the vertex information of the left hand on the specified parameter of the left hand is retained, and unidirectional direct influence of the vertex information of the right hand on the specified parameter of the right hand is retained. Through the method, the specified parameters with relatively poor precision may be influenced by virtue of the vertex information with relatively high precision, so that the precision of the specified parameters is improved, thus the vertex information is implicitly influenced by using the specified parameters with improved precision in the later period, and the vertex information of each independent object is constrained, furthermore the stability of the vertex information is improved. In addition,

$${∅}_{i}^{g r i d}$$

shown in FIG. 4 is a feature map obtained by an image coding network, and the first attention sub-unit may comprehensively analyze the feature map

$${∅}_{i}^{g r i d}$$

on the image layer based on

$${f}_{v}^{L} , {f}_{v}^{R} , {f}_{m}^{L} and {f}_{m}^{R}$$

being inputted to the first attention sub-unit, to output the feature information fᵢₙₜᵣₐ predicted for one hand. Specifically, the graph convolution subunit may first be used to perform comprehensive processing on

$${f}_{v}^{L} and {f}_{v}^{R}$$

so that spatial association (that is, local information) existing between adjacent vertices in the vertex information may be modeled to obtain vertex association feature, where the vertex association feature may be obtained by

$${f}_{v}^{R} and {f}_{v}^{L}$$

connecting in series after the graph convolution subunit is updated. Further, the vertex association feature,

$${f}_{m}^{L} and {f}_{m}^{R} ,$$

and feature map

$${∅}_{i}^{g r i d}$$

may be input to a Norm (normalized) layer at the same time, the output of the Norm (normalized) layer is used as an input of an MHA (attention calculation operation) layer. The first attention matrix is used as a predetermined parameter of the MHA layer, so that the first attention matrix may be processed by combining the attention parameters (Q, K, V) in the attention operation. After the output of the MHA layer and the vertex association feature output by the graph convolution subunit are further fused, it is inputted to the MLP (multi-layer perceptron) layer to obtain prediction information output by the first attention subunit. The second attention subunit may, based on the output result of the first attention subunit, analyze the attention mechanism further being adopted. The second attention matrix is configured to represent that the second attention subunit mainly retaining mutual influence of the specified parameters of the two objects and mutual influence of the vertex information, for example,

$${f}_{v}^{L}$$

influences

$${f}_{v}^{R} and {f}_{v}^{R}$$

also influences

$${f}_{v}^{L} ,$$

that is, the vertex information of the left hand and the vertex information of the right hand mutual influence each other; the right hand is also the same, and details are not described herein again. In addition, the unidirectional influence of the vertex information of the first object on the specified parameter of the second object is retained, and the unidirectional influence of the vertex information of the second object on the specified parameter of the first object is retained, that is,

$${f}_{v}^{L}$$

influences

$${f}_{m}^{R} and {f}_{v}^{R}$$

also influences

$${f}_{m}^{L} .$$

Furthermore, the second attention matrix described above may make the second attention subunit focuses more about influence of the objects with each other. In the foregoing manner, the second attention subunit may finally output three-dimensional reconstruction mesh information

$${\overline{f}}_{v}^{L} , {\overline{f}}_{v}^{R} , {\overline{f}}_{m}^{L} and {\overline{f}}_{m}^{R} .$$

It may be understood that, compared with

$${f}_{v}^{L} , {f}_{v}^{R} , {f}_{m}^{L} and {f}_{m}^{R} ,$$

the number of vertices of

$${\overline{f}}_{v}^{L} , {\overline{f}}_{v}^{R} , {\overline{f}}_{m}^{L} and {\overline{f}}_{m}^{R}$$

is more, and the specified parameter is more accurate.

In addition, the first information interaction unit shown in FIG. 4 illustrates two attention subunits, that is, the first attention subunit and the second attention subunit in series. The structures of the first attention subunit and the second attention subunit may be the same, both include a Norm (normalized) layer, an MHA (attention calculation operation) layer, and an MLP (multi-layer perceptron) layer, and specific principles may refer to related technologies, and details are not described herein again. The above is only an example structure of the first attention subunit, and in practical, the first attention subunit with other structures may also be adopted, and details are not described herein again. In addition, if only one independent object is analyzed, such as constructing the network only for one hand, the first information interaction unit may only set one attention subunit, such as setting only the first attention subunit. The specific requirements may be flexibly set according to requirements, which is not limited herein.

In order to further improve the accuracy of the three-dimensional reconstruction mesh information, on the basis of FIG. 2, the embodiment of the present disclosure further illustrates in FIG. 5 that the information prediction model further includes an information correction network, and on this basis, the image coding network is further configured to generate a feature map of the to-be-processed image, and the feature map may be, for example, a multi-scale feature map. The information correction network is configured to correct the three-dimensional reconstruction mesh information output by the information interaction network based on the feature map(s) of the to-be-processed image. That is, the three-dimensional reconstruction mesh information output by the information interaction network may be adjusted to further improve the accuracy of the three-dimensional reconstruction mesh information.

In some specific implementation examples, when correcting the three-dimensional reconstruction mesh information output by the information interaction network based on the feature map(s) of the to-be-processed image, the information correction network may refer to the following step a to step b:

Step a: project a mesh vertex in the three-dimensional reconstruction mesh information output by the information interaction network onto a feature map(s) of the to-be-processed image. In practical, all mesh vertices may be projected onto the feature map(s), or some mesh vertices may be selected for projection, which is not limited herein.

Step b: correct the three-dimensional reconstruction mesh information output by the information interaction network based on a feature map(s) projection result. Through the feature map of the to-be-processed image and the projection result of projecting the mesh vertex onto the feature map of the to-be-processed image, whether the position of the mesh vertex output by the information interaction network is accurate may be better measured, and the three-dimensional reconstruction mesh information output by the information interaction network may be adjusted. In some specific implementation examples, the information correction network includes a second information interaction unit, and a structure of the second information interaction unit may be the same as a structure of the first information interaction unit, so details are not described herein again; and step b may be performed with reference to the following steps b1 to b2.

Step b1, obtain information correction amount with the second information interaction unit based on the feature map projection result and the three-dimensional reconstruction mesh information output by the information interaction network. For example, the MLP network layer may be first used to process the feature map projection result to generate the vertex information and the specified parameter information obtained based on the feature map projection result. Then the three-dimensional reconstruction mesh information obtained based on the feature map projection result and the three-dimensional reconstruction mesh information output based on the information interaction network are simultaneously input to the second information interaction unit for processing. Then the result output by the second information interaction unit is convolved to obtain the information correction amount, where the information correction amount includes vertex correction amount and specified parameter correction amount.

In some specific implementation examples, there are a plurality of feature maps. Mesh vertex projections are respectively performed on the plurality of feature maps, and the feature map projection results may be fused through the MLP network layer to obtain a first feature. The first feature may be fused with vertex information in the three-dimensional reconstruction mesh information output by the information interaction network or intermediate information used to generate the vertex information, respectively, to obtain a first fusion result, and the first fusion result is used as part of input of the second information interaction unit. In addition, after being processed by the MLP network layer, the feature map projection result is further processed through the GAP network layer to obtain a second feature. The second feature may be fused with a specified parameter in the three-dimensional reconstruction mesh information output by the information interaction network or intermediate information used to generate the specified parameter, respectively, to obtain a second fusion result, and the second fusion result is used as part of input of the second information interaction unit. Then the second information interaction unit processes based on the first fusion result and the second fusion result, and outputs correction amount corresponding to each of the vertex information and the specified parameter.

Step b2, perform an adding processing on the information correction amount and the three-dimensional reconstruction mesh information output by the information interaction network, and using a result of the adding processing as the three-dimensional reconstruction mesh information of the target object output by the information prediction model.

Through the above method, the three-dimensional reconstruction mesh information output by the information interaction network may be corrected based on the projection result of the vertex output by the information interaction network on the feature map of the to-be-processed image. The corrected three-dimensional reconstruction mesh information is used as an output result of the information prediction model, and accuracy and reliability of the three-dimensional reconstruction mesh information obtained through the information prediction model are further ensured.

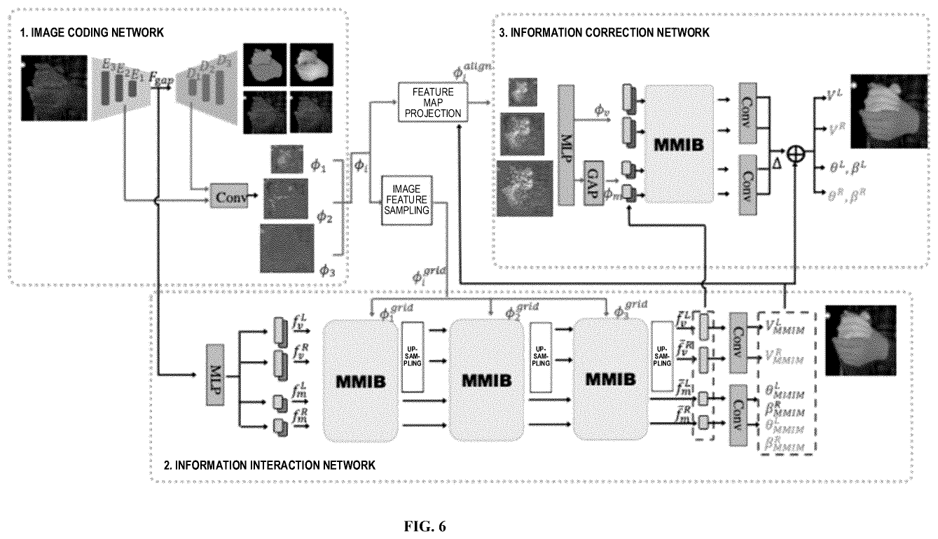

Based on the foregoing, an embodiment of the present disclosure provides a schematic structural diagram of an information prediction model as shown in FIG. 6, which provides a specific example implementation of an information prediction model, and in this example, an example in which the target object is two hands is used for description. In FIG. 6, a specific example structure of an image coding network, an information interaction network and an information modification network is specifically illustrated, wherein the MMIB in the information interaction network is referred to as a Mesh-Mano Interaction Block for short, and belongs to a module in a Mesh-Mano Interaction Module, and corresponds to the information interaction unit described above; and wherein, the Mesh-Mando Interaction Module (MMIM) corresponds to the aforementioned information interaction network. In FIG. 6, the image coding network may output the feature vector F_{gap} corresponding to the image to be processed to the information interaction network, or may output the multi-scale feature map Ø₁, Ø₂ and Ø₃, and input the target image obtained based on the multi-scale feature map by performing image feature sampling (that is, sampling based on a predetermined multiple) to the information interaction network. Specifically, for each feature map Øᵢ (a value of i is 1-3), sampling is performed based on a predetermined multiple, to obtain a corresponding target map

$${∅}_{i}^{grid} ,$$

and input to the 3 first attention subunits (MMIB) respectively. And the three-dimensional reconstruction mesh information

$$( {V}_{MMIM}^{L} , {V}_{MMIM}^{R} , {θ}_{MMIM}^{L} , {β}_{MMIM}^{L} , {θ}_{MMIM}^{R} , {β}_{MMIM}^{R} )$$

output based on the information interaction network, the mesh vertex obtained by the information interaction network prediction is projected onto the multi-scale feature map to obtain a feature map projection result

$${∅}_{i}^{align} ,$$

the feature map projection result includes the multi-scale feature map projected by the mesh vertex. The feature map projection result is fused through the MLP network layer, a feature Øᵥ corresponding to the vertex information (that is, the foregoing first feature), Øᵥ may be fused with the vertex information

$${\overline{f}}_{v}^{L} , {\overline{f}}_{v}^{R}$$

output by the information interaction network. And an obtained first fusion result is input to a second attention subunit MMIB in the information correction mesh. In addition, the feature map projection result is further fused through the MLP network layer and the GAP network layer sequentially, to obtain a feature Øₘ corresponding to the specified parameter (that is, the foregoing second feature), Øₘ may be fused with the specified parameter

$${\overline{f}}_{m}^{L} , {\overline{f}}_{m}^{R}$$

output by the information interaction network. And an obtained second fusion result is input to the second attention subunit MMIB in the information correction mesh, so that the second attention subunit determines an information correction amountΔ based on the first fusion result and the second fusion result. Specifically, the information correction amountΔ may be obtained by performing convolution processing on a result output by the second attention subunit for the vertex information and a result output for the specified parameter respectively. Then, the information correction amount Δ and the three-dimensional reconstruction mesh information

$$( {V}_{MMIM}^{L} , {V}_{MMIM}^{R} , {θ}_{MMIM}^{L} , {β}_{MMIM}^{L} , {θ}_{MMIM}^{R} , {β}_{MMIM}^{R} )$$

output by the information interaction network may be added, to obtain the three-dimensional reconstruction mesh information (V^{L}, V^{R}, θ^{L}, θ^{R}, θ^{L}, β^{R}) output by the information correction mesh. The foregoing Vis used to represent a vertex, θ and β are used to represent a posture parameter and a shape parameter respectively, both of which belong to the foregoing specified parameter. L is used to represent a left hand, R is used to represent a right hand, and a lower corner mark MMIM is used to represent a result belonging to an output of an information interaction network. Finally, the three-dimensional reconstruction mesh information (V^{L}, V^{R}, θ^{L}, θ^{R}, β^{L}, β^{R}) output by the information correction mesh may be used as an output result of the information prediction model. It should be noted that FIG. 6 is merely an example description, and the specific structure may also be flexibly set based on requirements, which is not limited herein.

Further, an embodiment of the present disclosure provides a training method of an information prediction model, for example, which may be described with reference to the following steps A to C to obtain the information prediction model.

Step A: obtain a training image that comprises a sample object and carries label information of the sample object, where a type of the sample object is the same as a type of the target object, the label information comprises a vertex information label and a specified parameter label. That is, the training image is labeled with true and accurate vertex information and specified parameters.

Step B: obtain a three-dimensional reconstruction mesh information of the sample object corresponding to the training image through a predetermined initial model. For specific obtaining manners, refer to the foregoing related content, and details are not described herein again.

Step C: train the initial model based on the three-dimensional reconstruction mesh information of the sample object and the label information, and using the trained initial model as the information prediction model. The training process of the initial model is a process of adjusting parameters of the initial model, and specifically, the model parameters may be reversely adjusted based on the vertex information of the sample object predicted by the initial model, the actual vertex information indicated by the specified parameter and the label information, and the actual specified parameter. The training is ended until the difference between the three-dimensional reconstruction mesh information output by the initial model and the label information meets a predetermined condition, and obtain the information prediction model capable of outputting an expected result. It may be understood that, in this embodiment of the present disclosure, when the label construction loss of the specified parameter is used and the model is adjusted based on the loss, an implicit constraint on the process of determining a prediction the vertex information of the model is also implemented.

For example, step C may be performed with reference to the following steps C1 to C3.

Step C1: determine a first loss based on a difference between the vertex information of the three-dimensional reconstruction mesh of the sample object and the vertex information label.

In practical, a predetermined first loss function may be adopted based on a difference between the vertex information of the three-dimensional reconstruction mesh of the sample object and the vertex information label, and a first loss function value (that is, the first loss) may be determined. The embodiment of the present disclosure does not limit the first loss function, e.g., the first loss function may be L1 loss. For example, the first loss may be determined based on the following formula:

$${L}_{V} = {\sum }_{h = L , R} {‖ {V}^{h} - {V}_{GT}^{h} ‖}_{1} + {‖ \prod ( {V}_{h} ) - \prod ( {V}_{GT}^{h} ) ‖}_{1} ,$$

where V represents vertex information, h represents left and right hands, L represents a left hand, R represents a right hand, GT represents a true value, and corresponds to the above label. The above loss may be regarded as a vertex loss to make the vertices of the three-dimensional reconstruction mesh predicted by the model more accurate as much as possible.

Step C2: determine a second loss based on a difference between a specified parameter of the three-dimensional reconstruction mesh of the sample object and the specified parameter label.

During a specific implementation, a predetermined second loss function may be adopted based on a difference between the specified parameter of the three-dimensional reconstruction mesh of the sample object and the specified parameter label, and a second loss function value (that is, the second loss) may be determined. The embodiment of the present disclosure does not limit the second loss function, e.g., the second loss function may also be a L1 loss. For example, the second loss may be determined based on the following formula:

$${L}_{P} = {\sum }_{h = L , R} {‖ {θ}^{h} - {θ}_{GT}^{h} ‖}_{1} + {‖ {β}^{h} - {β}_{GT}^{h} ‖}_{1} ,$$

θ and β are respectively used to represent the posture parameter and the shape parameter, and all belong to the foregoing specified parameter. The foregoing loss may be considered as a specified parameter loss, and the specified parameter used to construct the three-dimensional reconstruction mesh that is predicted by the model as much as possible is more accurate.

Step C3: train the initial model based on the first loss and the second loss.

In some implementations, a total loss may be determined based on the first loss and the second loss, and the model parameters are trained towards reducing the total loss until the total loss meets the requirement. In addition, other losses may also be introduced, collectively determining the total loss based on the first loss, the second loss, and other losses. For example, the label information further includes a normal vector label of the three-dimensional reconstruction mesh of the sample object; on this basis, step C3 may further include steps C3.1 to C3.3.

Step C3.1: determine a normal vector of the three-dimensional reconstruction mesh of the sample object based on the vertex information of the three-dimensional reconstruction mesh of the sample object.

Step C3.2: determine a third loss based on a difference between the normal vector of the three-dimensional reconstruction mesh of the sample object and the normal vector label.

During a specific implementation, a predetermined third loss function may be adopted based on a difference between the normal vector of the three-dimensional reconstruction mesh of the sample object and the normal vector label, and a third loss function value (that is, the third loss) may be determined. The embodiment of the present disclosure does not limit the third loss function, e.g., the third loss function may also be a L1 loss. For example, the third loss may be determined based on the following formula:

$${L}_{N} = {\sum }_{h = L , R} {\sum }_{f = 1}^{F} {\sum }_{i = 1}^{3} {‖ {e}_{f , i}^{h} \cdot {n}_{f , GT}^{h} ‖}_{1} ,$$

where F represents the total number of faces of the three-dimensional reconstruction mesh, f represents the f-th face; each face consists of 3 edges, i represents the i-th edge; e represents a vector of the i-th edge of the f-th face, and n represents an actual normal vector of the f-th face. In the foregoing formula, by converting a normal vector of the face formed by the vertex information predicted by the model into an edge vector, a point multiplication is performed by using the edge vector and the actual normal vector indicated by the label, so that analysis and operation are more convenient. The above loss may also be regarded as a smooth loss, that is to make the surface of the three-dimensional reconstruction mesh as smooth as possible.

Step C3.3: training the initial model based on the first loss, the second loss, and the third loss. For example, the total loss is determined in a weighted summation manner based on the first loss, the second loss, and the third loss, so that the initial model is trained based on the total loss, so that a finally trained model may output more accurate mesh vertices and specified parameters, and is smoother.

In conclusion, the information prediction model provided in the embodiments of the present disclosure not only determines a prediction of the vertex information of the three-dimensional reconstruction mesh of the target object in the to-be-processed image, but also determines a prediction of the specified parameter for constructing the three-dimensional reconstruction mesh, where the specified parameter is configured to constrain the vertex information. The mesh precision is ensured by predicting the vertex information, the reconstruction stability is ensured by constraining the vertex information through the specified parameters, thereby the object reconstruction effect is effectively improved.

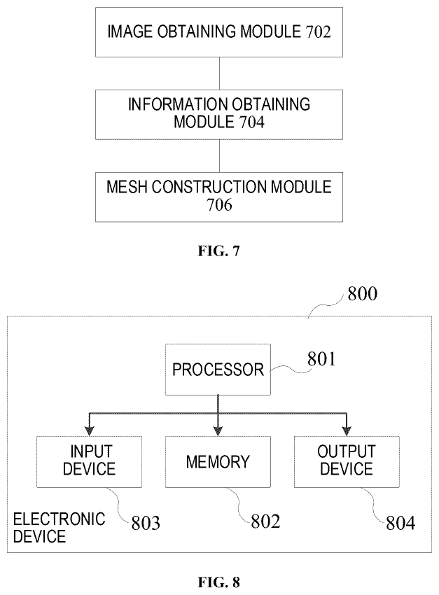

Corresponding to the foregoing object reconstruction method, FIG. 7 is a schematic structural diagram of an apparatus for object reconstruction according to an embodiment of the present disclosure. The apparatus may be implemented by software and/or hardware and may generally be integrated in an electronic device, as shown in FIG. 7, comprising:
an image obtaining module 702 is configured to obtain a to-be-processed image, wherein the to-be-processed image comprises a to-be-reconstructed target object;
an information obtaining module 704 is configured to obtain three-dimensional reconstruction mesh information of a target object corresponding to the to-be-processed image through a pre-trained information prediction model, wherein the three-dimensional reconstruction mesh information comprises vertex information of a three-dimensional reconstruction mesh and a specified parameter for constructing the three-dimensional reconstruction mesh, the specified parameter is configured to constrain the vertex information;
a mesh construction module 706 is configured to construct a three-dimensional reconstruction mesh of the target object based on the vertex information of the three-dimensional reconstruction mesh.

The information prediction model adopted by the apparatus provided in the embodiments of the present disclosure not only determines a prediction of the vertex information of the three-dimensional reconstruction mesh of the target object in the to-be-processed image, but also determines a prediction of the specified parameter for constructing the three-dimensional reconstruction mesh, where the specified parameter is configured to constrain the vertex information. The mesh precision is ensured by predicting the vertex information, the reconstruction stability is ensured by constraining the vertex information through the specified parameters, thereby the object reconstruction effect is effectively improved.

In some implementations, the information obtaining module 704 is specifically configured to: obtain the three-dimensional reconstruction mesh information of the target object corresponding to the to-be-processed image through a pre-trained information prediction model based on an attention mechanism.

In some implementations, the information obtaining module 704 is specifically configured to: obtain, based on a first attention matrix, the three-dimensional reconstruction mesh information of the target object corresponding to the to-be-processed image through the pre-trained information prediction model, wherein the first attention matrix is configured to at least retain unidirectional influence of the vertex information on the specified parameter.

In some embodiments, the target object comprises a first object and a second object associated with each other; the first attention matrix is further configured to retain unidirectional influence of vertex information of the first object on a specified parameter of the first object, and retain unidirectional influence of vertex information of the second object on a specified parameter of the second object.

In some embodiments, the target object comprises a first object and a second object associated with each other; and the information obtaining module 704 is specifically configured to: obtain, based on a second attention matrix, the three-dimensional reconstruction mesh information of the target object corresponding to the to-be-processed image through the pre-trained information prediction model; wherein the second attention matrix is configured to at least retain mutual influence between vertex information of the first object and vertex information of the second object, and is configured to retain mutual influence between a specified parameter of the first object and a specified parameter of the second object.

In some embodiments, the second attention matrix is further configured to retain unidirectional influence of the vertex information of the first object on the specified parameter of the second object, and is configured to retain unidirectional influence of the vertex information of the second object on the specified parameter of the first object.

In some embodiments, the information prediction model comprises an image coding network and an information interaction network; the image coding network is configured to perform feature extraction processing on the to-be-processed image to obtain a feature vector and a feature map(s) corresponding to the to-be-processed image; and the information interaction network is configured to obtain, based on the feature vector and the feature map(s), the three-dimensional reconstruction mesh information of the target object through the attention mechanism.

In some embodiments, the information interaction network comprises an information initial prediction unit and a first information interaction unit(s); the information initial prediction unit is configured to generate, based on the feature vector, initial information of the three-dimensional reconstruction mesh of the target object; and the first information interaction unit(s) is configured to determine, based on the initial information and the feature map(s), a prediction of the three-dimensional reconstruction mesh information of the target object through the attention mechanism.

In some embodiments, the first information interaction unit(s) comprises a plurality of first information interaction units, and the plurality of first information interaction units are connected in series; an initial first information interaction unit is configured to determine, based on the initial information and the feature map(s), a prediction of the three-dimensional reconstruction mesh information of the target object through the attention mechanism; and a non-initial first information interaction unit is configured to redetermine, based on the feature map(s) and three-dimensional reconstruction mesh information output by a preceding first information interaction unit, a prediction of the three-dimensional reconstruction mesh information of the target object through the attention mechanism, and the number of vertices included in vertex information output by the non-initial first information interaction unit is greater than the number of vertices included in vertex information determined by the preceding first information interaction unit.

In some embodiments, the feature map(s) comprises a plurality of feature maps, and different feature maps have different sizes; the plurality of feature maps correspond to a plurality of target maps; wherein the target map is obtained by sampling the feature map with a predetermined multiple, and the target map is configured to be inputted to the first information interaction unit, and target maps inputted to different first information interaction units are different.

In some embodiments, the target object comprises a first object and a second object associated with each other; the first information interaction unit comprises a graph convolution subunit and two attention subunits connected in series; the graph convolution subunit is configured to generate a vertex association feature based on vertex information of a first object and vertex information of a second object that are inputted to the information interaction unit, the vertex association feature is configured to be inputted to an initial attention subunit; the initial attention subunit, based on a first attention matrix, retains unidirectional influence of the vertex information of the first object on a specified parameter of the first object, and retains unidirectional influence of the vertex information of the second object on a specified parameter of the second object; an end attention subunit, based on a second attention matrix, retains mutual influence between the vertex information of the first object and the vertex information of the second object, and retains mutual influence between the specified parameter of the first object and the specified parameter of the second object, and retains unidirectional influence of the vertex information of the first object on the specified parameter of the second object, and retains unidirectional influence of the vertex information of the second object on the specified parameter of the first object.

In some embodiments, the information prediction model further comprises an information correction network; and the information correction network is configured to correct, based on the feature map(s) of the to-be-processed image, three-dimensional reconstruction mesh information output by the information interaction network.

In some implementations, the information correction network is specifically configured to: project a mesh vertex in the three-dimensional reconstruction mesh information output by the information interaction network onto the feature map(s) of the to-be-processed image; and correct, based on a feature map projection result, the three-dimensional reconstruction mesh information output by the information interaction network.

In some embodiments, the information correction network comprises a second information interaction unit; and the information correction network is specifically configured to: obtain information correction amount with the second information interaction unit based on the feature map projection result and the three-dimensional reconstruction mesh information output by the information interaction network; and perform an adding processing on the information correction amount and the three-dimensional reconstruction mesh information output by the information interaction network, and using a result of the adding processing as the three-dimensional reconstruction mesh information of the target object output by the information prediction model.

In some implementations, an embodiment of the present disclosure further includes a model training module, configured to obtain a training image that comprises a sample object and carries label information of the sample object; wherein a type of the sample object is the same as a type of the target object, the label information comprises a vertex information label and a specified parameter label; obtain a three-dimensional reconstruction mesh information of the sample object corresponding to the training image through a predetermined initial model; and the initial model based on the three-dimensional reconstruction mesh information of the sample object and the label information, and using the trained initial model as the information prediction model.

In some embodiments, the model training module is specifically configured to: determine a first loss based on a difference between vertex information of a three-dimensional reconstruction mesh of the sample object and the vertex information label; determine a second loss based on a difference between a specified parameter of the three-dimensional reconstruction mesh of the sample object and the specified parameter label; and train the initial model based on the first loss and the second loss.

In some embodiments, the label information further comprises a normal vector label of the three-dimensional reconstruction mesh of the sample object; the model training module is specifically configured to: determine, based on the vertex information of the three-dimensional reconstruction mesh of the sample object, a normal vector of the three-dimensional reconstruction mesh of the sample object; determine a third loss based on a difference between the normal vector of the three-dimensional reconstruction mesh of the sample object and the normal vector label; and train the initial model based on the first loss, the second loss, and the third loss.

An apparatus for object reconstruction provided in the embodiments of the present disclosure may perform the object reconstruction method provided by any embodiment of the present disclosure, and has functional modules and beneficial effects corresponding to the execution method.

A person skilled in the art may clearly understand that, for the convenience and brevity of description, the specific working process of the apparatus embodiments described above may refer to the corresponding processes in the method embodiments, and details are not described herein again.

An embodiment of the present disclosure further provides an electronic device, comprising: a processor; a memory for storing executable instructions for the processor; and a processor configured to read the executable instructions from the memory and execute the instructions to implement the method for object reconstruction.

FIG. 8 is a schematic structural diagram of an electronic device according to an embodiment of the present disclosure. As shown in FIG. 8, the electronic device 800 includes one or more processors 801 and memories 802.

The processor 801 may be a central processing unit (CPU) or other form of processing unit having data processing capabilities and/or instruction execution capabilities, and may control other components in the electronic device 800 to perform expected functions.

The memory 802 may include one or more computer program products, and the computer program product may include various forms of computer-readable storage media, such as volatile memory and/or non-volatile memory. The volatile memory may include, for example, random access memory (RAM) and/or cache memory. The non-volatile memory may include, for example, a read-only memory (ROM), a hard disk, a flash memory, or the like. The computer readable storage medium may store one or more computer program instructions, and the processor 801 may run the program instructions to implement the object reconstruction method and/or other expected functions of the embodiments of the present disclosure described above. Various content such as input signals, signal components, noise components, and the like may also be stored in the computer-readable storage medium.

In one example, the electronic device 800 may further include an input device 803 and an output device 804, and these components are interconnected by a bus system and/or other forms of connection mechanisms (not shown).

In addition, the input device 803 may further include, for example, a keyboard, a mouse, and the like.

The output device 804 may output various information to the outside, including determined distance information, direction information, and the like. The output device 804 may include, for example, a display, a speaker, a printer, and a communication network and their connected remote output devices, and the like.

Of course, for simplicity, only some of the components related to the present disclosure in the electronic device 800 are shown in FIG. 8, and components such as a bus, an input/output interface and the like are omitted. In addition, according to a specific application scenario, the electronic device 800 may further include any other suitable components.

In addition to the foregoing method and devices, an embodiment of the present disclosure may further be a computer program product, including a computer program instruction.

The computer program instruction, when executed by a processor, causes the processor to perform the method for object reconstruction provided in the embodiments of the present disclosure.

The computer program product for implementing the computer program code of the present disclosure may be written in any combination of one or more programming languages. The programming language includes an object oriented programming language, such as Java, C++, or the like, and also including a conventional procedural programming language, such as a “C” language or similar programming language. The program code may execute entirely on a user computing device, partially on a user device, as a stand-alone software package, partially on a user computing device and partially on a remote computing device, or entirely on a remote computing device or server.

In addition, the embodiments of the present disclosure may further be a computer-readable storage medium having stored computer program instructions thereon. The computer program instructions, when executed by a processor, cause the processor to perform the method for object reconstruction provided in the embodiments of the present disclosure.

The computer-readable storage medium may employ any combination of one or more readable media. The readable medium may be a readable signal medium or a readable storage medium. The readable storage medium may include, but is not limited to, an electric, magnetic, optical, electromagnetic, infrared, or semiconductor system, apparatus, or device, or any combination thereof. More specific examples (non-exhaustive list) of the readable storage medium include: an electrical connection having one or more wires, a portable disk, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

An embodiment of the present disclosure further provides a computer program product, including a computer program/instruction, and when the computer program/instruction is executed by a processor, the method object reconstruction in the embodiments of the present disclosure is implemented.

It may be understood that, before the technical solutions disclosed in the embodiments of the present disclosure are used, the types of personal information, the usage scope, the usage scenario and the like related to the present disclosure should be notified to the user in an appropriate manner according to relevant laws and regulations and obtain an authorization of the user.

For example, in response to receiving an active request from a user, prompt information is sent to the user to explicitly prompt the user that the requested operation will need to acquire and use the personal information of the user. Therefore, the user may autonomously select whether to provide personal information to software or hardware executing an operation of a technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It should be noted that, in this specification, relational terms such as “first” and “second” are merely used to distinguish one entity or operation from another entity or operation, and do not necessarily require or imply that any such actual relationship or sequence exists between these entities or operations. Moreover, the terms “comprising,” “including,” or any other variation thereof are intended to cover a non-exclusive inclusion, such that a process, method, article, or device comprising not only those elements, but also other elements not expressly listed, or elements inherent for such a process, method, article, or device. Without further restriction, the elements defined by the statement “including one” do not preclude the presence of additional identical elements in the process, method, article, or device that includes the elements.

The above descriptions are only specific embodiments of the present disclosure, so that those skilled in the art can understand or implement the present disclosure. Various modifications to these embodiments will be apparent to those skilled in the art, the general principles defined herein may be implemented in other embodiments without departing from the spirit or scope of the present disclosure. Accordingly, the present disclosure will not be limited to these embodiments described herein, but is to be accorded the widest scope consistent with the principles and novel features disclosed herein.

1. A method for object reconstruction comprising:
obtaining a to-be-processed image; wherein the to-be-processed image comprises a to-be-reconstructed target object;
obtaining three-dimensional reconstruction mesh information of a target object corresponding to the to-be-processed image through a pre-trained information prediction model; wherein the three-dimensional reconstruction mesh information comprises vertex information of a three-dimensional reconstruction mesh and a specified parameter for constructing the three-dimensional reconstruction mesh, the specified parameter is configured to constrain the vertex information;
constructing, based on the vertex information of the three-dimensional reconstruction mesh, a three-dimensional reconstruction mesh of the target object.

2. The method of claim 1, wherein obtaining the three-dimensional reconstruction mesh information of the target object corresponding to the to-be-processed image through the pre-trained information prediction model comprises:
obtaining, based on an attention mechanism, the three-dimensional reconstruction mesh information of the target object corresponding to the to-be-processed image through the pre-trained information prediction model.

3. The method of claim 2, wherein obtaining, based on the attention mechanism, the three-dimensional reconstruction mesh information of the target object corresponding to the to-be-processed image through the pre-trained information prediction model comprises:
obtaining, based on a first attention matrix, the three-dimensional reconstruction mesh information of the target object corresponding to the to-be-processed image through the pre-trained information prediction model; wherein the first attention matrix is configured to at least retain unidirectional influence of the vertex information on the specified parameter.

4. The method of claim 3, wherein the target object comprises a first object and a second object associated with each other; the first attention matrix is further configured to retain unidirectional influence of vertex information of the first object on a specified parameter of the first object, and retain unidirectional influence of vertex information of the second object on a specified parameter of the second object.

5. The method of claim 2, wherein the target object comprises a first object and a second object associated with each other;
obtaining, based on the attention mechanism, the three-dimensional reconstruction mesh information of the target object corresponding to the to-be-processed image through the pre-trained information prediction model comprises:
obtaining, based on a second attention matrix, the three-dimensional reconstruction mesh information of the target object corresponding to the to-be-processed image through the pre-trained information prediction model; wherein the second attention matrix is configured to at least retain mutual influence between vertex information of the first object and vertex information of the second object, and is configured to retain mutual influence between a specified parameter of the first object and a specified parameter of the second object.

6. The method of claim 5, wherein the second attention matrix is further configured to retain unidirectional influence of the vertex information of the first object on the specified parameter of the second object, and is configured to retain unidirectional influence of the vertex information of the second object on the specified parameter of the first object.

7. The method of claim 2, wherein the information prediction model comprises an image coding network and an information interaction network;
the image coding network is configured to perform feature extraction processing on the to-be-processed image to obtain a feature vector and at least one feature map corresponding to the to-be-processed image;
the information interaction network is configured to obtain, based on the feature vector and the at least one feature map, the three-dimensional reconstruction mesh information of the target object through the attention mechanism.

8. The method of claim 7, wherein the information interaction network comprises an information initial prediction unit and at least one first information interaction unit;
the information initial prediction unit is configured to generate, based on the feature vector, initial information of the three-dimensional reconstruction mesh of the target object;
the at least one first information interaction unit is configured to determine, based on the initial information and the at least one feature map, a prediction of the three-dimensional reconstruction mesh information of the target object through the attention mechanism.

9. The method of claim 8, wherein the at least one first information interaction unit comprises a plurality of first information interaction units, and the plurality of first information interaction units are connected in series;
an initial first information interaction unit is configured to determine, based on the initial information and the at least one feature map, a prediction of the three-dimensional reconstruction mesh information of the target object through the attention mechanism;
a non-initial first information interaction unit is configured to redetermine, based on the at least one feature map and three-dimensional reconstruction mesh information output by a preceding first information interaction unit, a prediction of the three-dimensional reconstruction mesh information of the target object through the attention mechanism, and the number of vertices included in vertex information output by the non-initial first information interaction unit is greater than the number of vertices included in vertex information determined by the preceding first information interaction unit.

10. The method of claim 9, wherein the at least one feature map comprises a plurality of feature maps, and different feature maps have different sizes; the plurality of feature maps correspond to a plurality of target maps; wherein the target map is obtained by sampling the feature map with a predetermined multiple, and the target map is configured to be inputted to the first information interaction unit, and target maps inputted to different first information interaction units are different.

11. The method of claim 8, wherein the target object comprises a first object and a second object associated with each other; the first information interaction unit comprises a graph convolution subunit and two attention subunits connected in series;
the graph convolution subunit is configured to generate a vertex association feature based on vertex information of a first object and vertex information of a second object that are inputted to the information interaction unit, the vertex association feature is configured to be inputted to an initial attention subunit;
the initial attention subunit, based on a first attention matrix, retains unidirectional influence of the vertex information of the first object on a specified parameter of the first object, and retains unidirectional influence of the vertex information of the second object on a specified parameter of the second object;
an end attention subunit, based on a second attention matrix, retains mutual influence between the vertex information of the first object and the vertex information of the second object, and retains mutual influence between the specified parameter of the first object and the specified parameter of the second object, and retains unidirectional influence of the vertex information of the first object on the specified parameter of the second object, and retains unidirectional influence of the vertex information of the second object on the specified parameter of the first object.

12. The method of claim 7, wherein the information prediction model further comprises an information correction network;
the information correction network is configured to correct, based on the at least one feature map of the to-be-processed image, three-dimensional reconstruction mesh information output by the information interaction network.

13. The method of claim 12, wherein correcting, based on the at least one feature map of the to-be-processed image, the three-dimensional reconstruction mesh information output by the information interaction network comprises:
projecting a mesh vertex in the three-dimensional reconstruction mesh information output by the information interaction network onto the at least one feature map of the to-be-processed image;
correcting, based on a feature map projection result, the three-dimensional reconstruction mesh information output by the information interaction network.

14. The method of claim 8, wherein the information correction network comprises a second information interaction unit;
correcting, based on the feature map projection result, the three-dimensional reconstruction mesh information output by the information interaction network comprises:
obtaining information correction amount with the second information interaction unit based on the feature map projection result and the three-dimensional reconstruction mesh information output by the information interaction network;
performing an adding processing on the information correction amount and the three-dimensional reconstruction mesh information output by the information interaction network, and using a result of the adding processing as the three-dimensional reconstruction mesh information of the target object output by the information prediction model.

15. The method of claim 1, wherein the information prediction model is trained by the following steps:
obtaining a training image that comprises a sample object and carries label information of the sample object; wherein a type of the sample object is the same as a type of the target object, the label information comprises a vertex information label and a specified parameter label;
obtaining a three-dimensional reconstruction mesh information of the sample object corresponding to the training image through a predetermined initial model;
training the initial model based on the three-dimensional reconstruction mesh information of the sample object and the label information, and using the trained initial model as the information prediction model.

16. The method of claim 15, wherein training the initial model based on the three-dimensional reconstruction mesh information of the sample object and the label information comprises:
determining a first loss based on a difference between vertex information of a three-dimensional reconstruction mesh of the sample object and the vertex information label;
determining a second loss based on a difference between a specified parameter of the three-dimensional reconstruction mesh of the sample object and the specified parameter label;
training the initial model based on the first loss and the second loss.

17. The method of claim 16, wherein the label information further comprises a normal vector label of the three-dimensional reconstruction mesh of the sample object;
training the initial model based on the first loss and the second loss comprises:
determining, based on the vertex information of the three-dimensional reconstruction mesh of the sample object, a normal vector of the three-dimensional reconstruction mesh of the sample object;
determining a third loss based on a difference between the normal vector of the three-dimensional reconstruction mesh of the sample object and the normal vector label;
training the initial model based on the first loss, the second loss, and the third loss.

18. (canceled)

19. An electronic device comprising:
a processor; and
a memory for storing executable instructions for the processor;
the processor being configured to read the executable instructions from the memory, and execute the instructions to perform acts comprising:
obtaining a to-be-processed image; wherein the to-be-processed image comprises a to-be-reconstructed target object;
obtaining three-dimensional reconstruction mesh information of a target object corresponding to the to-be-processed image through a pre-trained information prediction model; wherein the three-dimensional reconstruction mesh information comprises vertex information of a three-dimensional reconstruction mesh and a specified parameter for constructing the three-dimensional reconstruction mesh, the specified parameter is configured to constrain the vertex information;
constructing, based on the vertex information of the three-dimensional reconstruction mesh, a three-dimensional reconstruction mesh of the target object.

20. A non-transitory computer-readable storage medium storing a computer program, the computer program being configured to perform acts comprising:
obtaining a to-be-processed image; wherein the to-be-processed image comprises a to-be-reconstructed target object;
obtaining three-dimensional reconstruction mesh information of a target object corresponding to the to-be-processed image through a pre-trained information prediction model; wherein the three-dimensional reconstruction mesh information comprises vertex information of a three-dimensional reconstruction mesh and a specified parameter for constructing the three-dimensional reconstruction mesh, the specified parameter is configured to constrain the vertex information;
constructing, based on the vertex information of the three-dimensional reconstruction mesh, a three-dimensional reconstruction mesh of the target object.

21. The device of claim 19, wherein obtaining the three-dimensional reconstruction mesh information of the target object corresponding to the to-be-processed image through the pre-trained information prediction model comprises:
obtaining, based on an attention mechanism, the three-dimensional reconstruction mesh information of the target object corresponding to the to-be-processed image through the pre-trained information prediction model.
